(19) United States
(12) Patent Application Publication
(10) Pub. No.: US 2026/0037316 A1
(43) Pub. Date: Feb. 5, 2026

(54) ACCELERATOR WITH MIXED CONNECTIVITY TOPOLOGY, ELECTRONIC DEVICE AND OPERATION METHOD THEREOF

(71) Applicant: Samsung Electronics Co., Ltd., Suwon-si (KR)

(72) Inventor: Seok KANG, Suwon-si (KR)

(73) Assignee: Samsung Electronics Co., Ltd., Suwon-si (KR)

(21) Appl. No.: 19/094,759

(22) Filed: Mar. 28, 2025

(30) Foreign Application Priority Data
Jul. 30, 2024 (KR) 10-2024-0101246
Sep. 13, 2024 (KR) 10-2024-0125905

(51) Int. Cl. G06F 9/50; G06F 15/80

(52) U.S. Cl. CPC G06F 9/5027; G06F 15/80

(57) ABSTRACT

An accelerator includes: switches having a mesh topology; and processing units connected to the switches, respectively, wherein the mesh topology comprises nodes corresponding to the switches, and edges configured to connect the nodes, and wherein the nodes comprise a given node that is connected to all of its orthogonally adjacent nodes in the mesh topology that are orthogonally adjacent to the given node, and connected to a set number of diagonally adjacent nodes among one or more its diagonally adjacent nodes in the mesh topology that are diagonally adjacent to the given node.

### CROSS-REFERENCE TO RELATED APPLICATIONS

This application claims the benefit under 35 USC § 119(a) of Korean Patent Application No. 10-2024-0101246, filed on Jul. 30, 2024, and Korean Patent Application No. 10-2024-0125905, filed on Sep. 13, 2024, in the Korean Intellectual Property Office, the disclosures of which are incorporated herein in their entireties by reference.

### BACKGROUND

### 1. Field

Example embodiments relate to an accelerator with a mixed connectivity topology, an electronic device and an operation method thereof.

### 2. Description of Related Art

Artificial intelligence (AI)-specific processors and graphics processing units (GPUs) are being used to accelerate the computation of AI models. To improve the learning and inference performance of AI models, accelerators optimized for parallel processing are being utilized, and accelerators optimized for large-scale operations can significantly improve the processing speed of the AI models.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an accelerator comprising switches having a mesh topology; and processing units connected to the switches, respectively, wherein the mesh topology comprises nodes corresponding to the switches, and edges configured to connect the nodes, and wherein the nodes comprise a given node that is connected to all of its orthogonally adjacent nodes in the mesh topology that are orthogonally adjacent to the given node, and connected to a set number of diagonally adjacent nodes among one or more its diagonally adjacent nodes in the mesh topology that are diagonally adjacent to the given node.

In another general aspect, an electronic device includes: one or more processors; an accelerator comprising switches having a mesh topology, wherein the mesh topology comprises nodes corresponding to the switches and edges configured to connect the nodes, and processing units connected to the switches, respectively; and a memory storing instructions configured to cause the one or more processors to: determine trees based on the mesh topology; and transmit, to the accelerator, a command for the accelerator to perform an operation using the trees, wherein the mesh topology comprises fully connected blocks of first nodes and partially-connected blocks of second nodes that are distinct from the fully connected blocks, wherein the first nodes in each fully connected block are connected to each other, wherein diagonally adjacent second nodes in each partially-connected block are not connected to each other and the orthogonally adjacent second nodes in each partially-connected block are connected to each other, and wherein the fully connected blocks are separated from each other by the partially-connected blocks.

In another general aspect, an operation method of an electronic device comprising an accelerator comprising switches having a mesh topology and that are connected to respectively corresponding processing units, a memory, and a processor, the operation method comprising: identifying trees based on the mesh topology; and transmitting a command for the accelerator to perform an operation using the trees to the accelerator, wherein the mesh topology comprises nodes corresponding to the switches, and edges configured to connect the nodes, and wherein the nodes comprise a given node that is connected to all of its orthogonally adjacent nodes in the mesh topology that are orthogonally adjacent to the given node, and connected to a set number of diagonally adjacent nodes among one or more its diagonally adjacent nodes in the mesh topology that are diagonally adjacent to the given node

A non-transitory computer-readable recording medium stores a program for executing any of the methods on a computer.

Other features and aspects will be apparent from the following detailed description, the drawings, and the claims.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates an accelerator according to one or more embodiments;

FIG. 2 illustrates an electronic device including an accelerator according to one or more embodiments;

FIG. 3 illustrates a 2D mesh topology according to one or more embodiments;

FIG. 4 illustrates a perspective view of a 3D mesh topology according to one or more embodiments;

FIG. 5 illustrates an example connection relationships between switches and processing units according to one or more embodiments;

FIG. 6 illustrates another example of connection relationships between switches and processing units according to one or more embodiments;

FIG. 7 illustrates disjoint spanning trees identified based on a mesh topology, according to one or more embodiments;

FIG. 8 illustrates edges included in disjoint spanning trees among the edges included in the mesh topology, according to one or more embodiments;

FIG. 9 illustrates a method of performing operations using a disjoint spanning tree, according to one or more embodiments;

FIG. 10 illustrates a method of performing operations by dividing the mesh topology, according to one or more embodiments;

FIG. 11 illustrates a comparison between a case of transmitting data based on a mesh topology according to one or more embodiments and a case of transmitting data based on a first mesh topology, in terms of latency and speed of data transmission, according to one or more embodiments; and

FIG. 12 illustrates an operation method of an electronic device according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

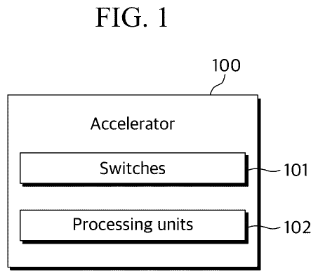

FIG. 1 illustrates an accelerator according to one or more embodiments.

Referring to FIG. 1, an accelerator 100 may include switches 101 having a mesh topology and processing units 102 connected to the switches 101. The accelerator 100 may be dedicated hardware suitable for quickly processing neural network operations. More specifically, the accelerator 100 may be a device for sequentially performing various parallel operations using the processing units 102 connected to the switches 101. The accelerator 100 may quickly process operations such as convolution, activation, pooling, normalization, and/or all-reduce in neural networks, as non-limiting examples. In an example implementation, the operation performed by the accelerator 100 may be an all-reduce operation, and the parallel operation performed on the plurality of processing units 102 may be an addition operation. However, the operation performed by the accelerator 100 is not limited thereto. While switches 101 and processing units 102 are physical components included in accelerator 100, nodes, included in the mesh topology, may be terms used to describe the connectivity in the mesh topology.

A mesh topology may allow data to be transmitted through various paths through edges that connect nodes. The node connections described with reference to mesh topology are interconnections between nodes, unless the context suggests otherwise. Edges between a first node and a second node may include (i) edges having a direction from the first node to the second node and (ii) edges having a direction from the second node to the first node. Depending on the arrangement and connection relationships of the nodes included in the mesh topology, the mesh topology may be either a 2D topology or a 3D topology. In the case of a topology where nodes are fully connected, if there is a problem with a specific node, data may still be transmitted through other routes in the mesh topology. Thus, the fully connected topology has high reliability and performance. However, the fully connected topology has high complexity and cost compared to other topologies. On the other hand, in the case of a topology where nodes are sparsely interconnected, if there is a problem with a particular node, data may be unable to be transmitted through other routes, but the complexity and cost may less than a fully connected topology. Accordingly, it may be more effective for a mesh topology to include both a part where the nodes are fully interconnected and a part where the nodes are sparsely interconnected.

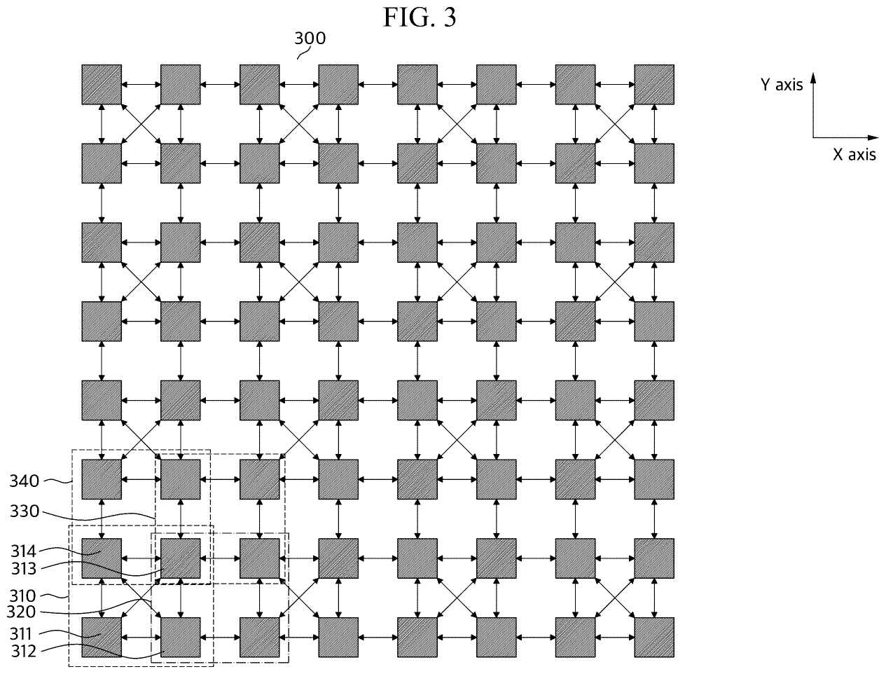

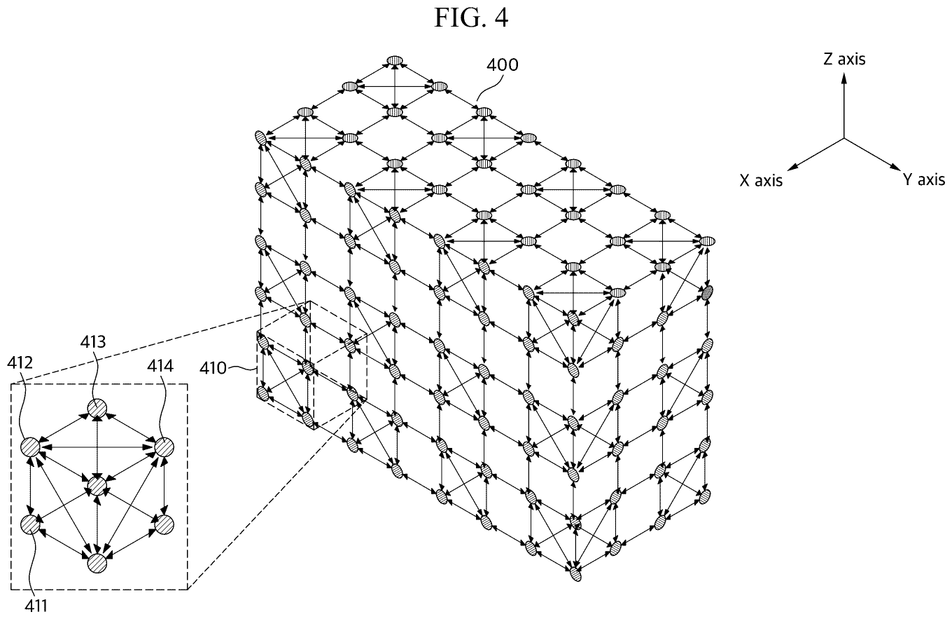

In an example embodiment, the mesh topology contains parts consisting of fully connected nodes and parts consisting of sparsely connected nodes. The mesh topology has high reliability and performance but moderate complexity and cost. The mesh topology may generally have a rectilinear form. With regard thereto, each node may be connected to all the nodes that are orthogonally adjacent nodes thereto, and some nodes may also be connected to a set number of nodes diagonally adjacent thereto. In the case of a 2D mesh topology, the set number may be 1. In the case of a 3D mesh topology, the set number may be 4. The same concept may be extended to higher dimension topologies (e.g., a 4D mesh topology). The connection relationships between the nodes included in the mesh topologies are described with reference to FIG. 3 and FIG. 4.

In an example implementation, each of the processing units 102 may be a device for performing various parallel operations (each processing unit may also internally perform operations in parallel). With regard thereto, each of the processing units 102 may include a memory and at least one between a GPU and a neural processing unit (NPU). A GPU or an NPU may perform certain operations based on (i) values stored in their memory and (ii) values received from other processing units. Further, the memory may be directly accessed by the GPU/NPU; the memory may include on-chip memory. The memory may include scratchpad memory and/or cache memory, as non-limiting examples. For example, the memory may include, but is not limited to, static random access memory (SRAM).

A processing unit may transmit a result value from performing the predetermined operation (the result value being based on the values received from the one or more adjacent processing units and the value stored in its memory) to an adjacent processing unit. In other words, each of the processing units 102 may perform parallel operations in sequence by interacting with one or more adjacent processing units through the connected switches.

Each of the switches 101 may be a device by which processing units connected thereto interact with each other. Since the switches 101 have a mesh topology, the first node and the second node included in the mesh topology may be connected, the first node and the first switch may correspond, and the second node and the second switch may correspond. The processing unit connected to the first switch and the processing unit connected to the second switch may directly exchange data with each other via the first switch and the second switch.

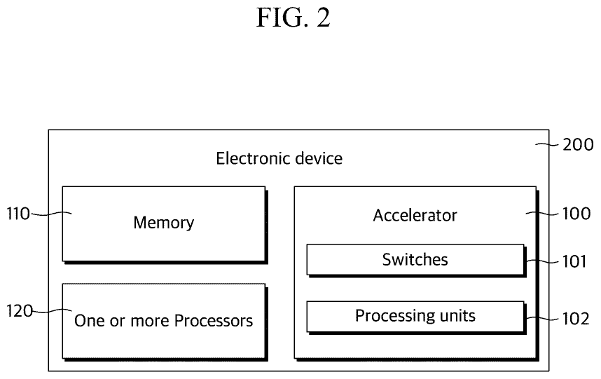

FIG. 2 illustrates an electronic device including an accelerator according to one or more embodiments.

Referring to FIG. 2, an electronic device 200 may include the accelerator 100, a memory 110 and one or more processors 120. The accelerator 100 may include the switches 101 having a mesh topology, and the processing units 102 connected to the switches 101.

The memory 110 may store commands to be executed by the one or more processors 120. The memory 110 may be referred to as storage and may be volatile memory and/or non-volatile memory. The memory 110 may store the result value computed by the operation performed by the accelerator 100.

The one or more processors 120 may control the overall operation of the accelerator 100. The one or more processors 120 may be, but is not limited to, a central processing unit (CPU) (in practice, the one or more processors 120 may be multiple CPUs). The one or more processors 120 may transmit commands for the accelerator 100 to perform operations. More specifically, the one or more processors 120 may transmit commands to the accelerator 100 to control various operations to be performed on the accelerator 100. With regard thereto, the one or more processors 120 may identify trees based on a mesh topology, and may use the trees to transmit commands to the accelerator 100 for the accelerator 100 to perform operations. The accelerator 100, which receives a command from the one or more processors 120, controls parallel operations to be performed sequentially on each of the processing units 102, and thus an operation corresponding to the received command may be performed.

FIG. 3 illustrates a 2D mesh topology according to one or more embodiments.

Referring to FIG. 3, a 2D mesh topology 300 may consist of 64 nodes, as a non-limiting example. Edges/connections between two nodes in the 2D mesh topology 300 may be bidirectional. In an example embodiment, the 2D mesh topology 300 may be a configuration in which 8 nodes are arranged in the x-axis direction and also the same number of nodes (e.g., 8) are arranged in the y-axis direction. However, the 2D mesh topology 300 is not limited thereto; the number of nodes arranged in the x-direction may differ from the number of nodes arranged in the y-direction. In brief, the 2D mesh topology may be a matrix-like structure of nodes.

A block in the 2D mesh topology may be composed of four adjacent nodes forming a rectangular structure. With regard thereto, a block in the 2D mesh topology consists of four nodes, and may also be called a quad. Depending on whether all nodes included in a block are connected to each other (each is connected to all the others), a block may be a fully connected block or, conversely a sparsely connected block (e.g., each is only connected to its non-diagonal neighbors). The sparsely connected block may be referred as a partially-connected block. In the present disclosure, in the 2D mesh topology, two nodes being adjacent may mean that the two nodes are included in the same block.

In an example embodiment, assuming a rectilinear arrangement of nodes, orthogonally adjacent nodes among the nodes included in each of sparsely connected blocks 320, 330 and 340 may be sparsely (not fully) connected to each other. Here, the orthogonal direction may be determined based on the direction between a single node and nodes closest to the single node in the mesh topology. “Single node” refers to an arbitrary given node among the nodes included in the mesh topology. In FIG. 3, the orthogonal direction in the 2D mesh topology may include the x-axis direction and the y-axis direction. Diagonally adjacent nodes among the nodes included in each of the sparsely connected blocks 320, 330 and 340 are not connected to each other.

In another example embodiment, each node included in each fully connected block 310 may be connected to each other node in its block. Referring to FIG. 3, a first node 311, second nodes 312 and 314, and a third node 313 may each be connected to each other. Specifically, the first node 311 and the third node 313 are located diagonally from each other, but may be connected to each other. Further, the second node 312 and the second node 314 are also located diagonally from each other, but may be connected to each other. The diagonal direction in the 2D mesh topology may include the xy-axis direction.

According to an example embodiment, fully connected blocks and sparsely connected blocks of the 2D mesh topology may be arranged in a set pattern. More specifically, multiple fully connected blocks included in the 2D mesh topology may be arranged so as not to share the same nodes with any other fully connected block. Further, the blocks at the four corner nodes of the 2D mesh topology may each be a fully connected block. In other words, any block that shares at least one node with a fully connected block may be a sparsely connected block. Referring to FIG. 3, the 2D mesh topology 300 may contain 16 fully connected blocks. Put another way, the 2D mesh topology with a rectilinear arrangement (e.g., matrix form) of nodes may have all nodes connected to all of their orthogonally adjacent nodes, and fully connected blocks/quads of the nodes may only be connected to each other with orthogonal (non-diagonal) connections (fully connected blocks may be adjacent to each other but do not overlap). Put yet another way, the 2D mesh topology may consist of a matrix of fully connected quads/blocks, but neighboring nodes in adjacent fully connected quads/blocks are only connected to each other orthogonally.

When nodes included in the 2D mesh topology have an N×N arrangement, a block consisting of 4 nodes may have an N-1×N-1 layout. At this time, blocks located at an odd number position in both the x-axis and y-axis directions may be fully connected blocks, and blocks located at an even number position in at least one of the x-axis direction and the y-axis direction may be a sparsely connected block. For example, among blocks 310, 320, 330 and 340, only the block 310, which is located first in both the x-axis direction and the y-axis direction, may be a fully connected block.

In an example embodiment, when fully connected blocks and sparsely connected blocks of the 2D mesh topology are placed in a set pattern as described above, a single node among a plurality of nodes is connected to all of its orthogonally adjacent nodes that are orthogonally adjacent to the single node, and may be connected diagonally to only a single diagonally adjacent node among its diagonally adjacent nodes that are diagonally adjacent to the single node. The orthogonally adjacent nodes of a single node may be nodes adjacent in the x-axis direction and nodes adjacent in the y-axis direction while being included in the same block as the single node. Diagonally adjacent nodes among the nodes adjacent to a single node may be its adjacent nodes that are not orthogonally adjacent. Since multiple fully connected blocks included in the 2D mesh topology are arranged in order not to share the same nodes (not overlap, topologically), an arbitrary node included in the 2D mesh topology may only be included in only one fully connected block. However, depending on whether the arbitrary node included in the 2D mesh topology is a corner node, an edge node, or an interior node, the arbitrary node may be included in different numbers of sparsely connected blocks.

According to an example implementation, among the nodes included in the 2D mesh topology 300, four nodes located at the corners of the 2D mesh topology may be corner nodes. A corner node may be included in only one fully connected block and may not be included in a sparsely connected block. In an example embodiment, the first node 311 may be a corner node. The first node 311 may be connected to both orthogonally adjacent nodes that are orthogonally adjacent to the first node 311, and be connected to one diagonally adjacent node that is diagonally adjacent to the first node 311. Referring to FIG. 3, two orthogonally adjacent nodes that are orthogonally adjacent to the first node 311 may include the second nodes 312 and 314, and one diagonally adjacent node that are diagonally adjacent to the first node 311 may be the third node 313.

According to an example implementation, among the nodes included in the 2D mesh topology 300, 24 nodes located on the edges of the 2D mesh topology 300 that are not corner nodes may be edge nodes. The edge nodes may be included in one fully connected block and one sparsely connected block. The second nodes 312 and 314 may be edge nodes. The second node 312 may be connected to all three of its orthogonally adjacent nodes, and may be connected to one of its two diagonally adjacent nodes that are diagonally adjacent to the second node 312. Referring to FIG. 3, three orthogonally adjacent nodes may include the first node 311 and the third node 313, and one diagonally adjacent node may be the second node 314. The second node 314 may also be connected to adjacent nodes similarly to the second node 312.

According to an example implementation, among the nodes included in the 2D mesh topology 300, 36 nodes located inside the 4 edges of the 2D mesh topology 300 may be interior nodes (nodes that are not edge or corner nodes). Each interior node may be contained in only one fully connected block and three sparsely connected blocks. The third node 313 may be an interior node. The third node 313 may be connected to all four of its orthogonally adjacent nodes, and may be connected to one of its four diagonally adjacent nodes that are diagonally adjacent to the third node 313. Referring to FIG. 3, the four orthogonally adjacent nodes may include the second nodes 312 and 314, and the one diagonally adjacent node may be the first node 311.

FIG. 4 illustrates a perspective view of a 3D mesh topology according to one or more embodiments. Generally, the 3D mesh topology may have the same topology of the 2D mesh topology 300, but extended to a third dimension.

Referring to FIG. 4, a 3D mesh topology 400 may consist of 192 nodes, as a non-limiting example. Among the nodes included in the 3D mesh topology 400, edges/connections between two nodes are bidirectional. In an example implementation, the 3D mesh topology 400 the nodes may be arranged in a cubic matrix form, and may be configured with 4, 6, and 8 nodes arranged in the x-axis direction, the y-axis direction, and the z-axis direction, respectively. However, the 3D mesh topology 400 is not limited thereto. The 3D mesh topology may have a variety of nodes arranged in the x-axis direction, the y-axis direction, and the z-axis direction.

According to an example implementation, a block in the 3D mesh topology may be composed of eight adjacent nodes forming a hexahedral structure. With regard thereto, since a block in the 3D mesh topology consists of 8 nodes, the block may specifically be a cube in some implementations. Depending on whether all nodes included in a block are connected, the block may be a fully connected block or a sparsely connected block. In the 3D mesh topology, two nodes being adjacent means that the two nodes are included in the same block.

Nodes included in each block 410 may be connected to each other. Referring to FIG. 4, a first node 411, a second node 412, a third node 413 and a fourth node 414 may be connected to each other. Specifically, even though the first node 411 and the third node 413 are located diagonally from each other, the first node 411 and the third node 413 may be connected to each other. Further, even though the first node 411 and the fourth node 414 are also located diagonally from each other, the first node 411 and the fourth node 414 may be connected to each other. The diagonal directions in the 3D mesh topology may include the xy, yz, zx, and xyz axis directions. In other words, the block 410 may be a fully connected block.

In another example implementation, with regard to other blocks that share at least one of the nodes included in the block 410, orthogonally adjacent nodes among the nodes included in different blocks are connected to each other. Here, the orthogonal direction may be determined based on the direction between a single node and nodes that are closet to the single node in the mesh topology. In FIG. 4, the orthogonal direction in the 3D mesh topology includes the x-axis direction, the y-axis direction and the z-axis direction. Some (or all) of the diagonally adjacent nodes among nodes included in different blocks may not be connected to each other. In other words, any other block that shares at least one of its nodes with the block 410 may be a sparsely connected block.

According to an example embodiment, fully connected blocks and sparsely connected blocks of the 3D mesh topology may be arranged in a set pattern. More specifically, fully connected blocks included in the 3D mesh topology may be placed in order not to share the same nodes (i.e., not intersect). Further, the blocks at the eight corner nodes of the 3D mesh topology may be fully connected blocks. In other words, any block that shares at least a single node with a fully connected block may be a sparsely connected block. Referring to FIG. 4, the 3D mesh topology 400 may contain 24 fully connected blocks. Put another way, the 3D mesh topology may consist of a 3D matrix of fully connected blocks of nodes (8 nodes each) that do not overlap/intersect, and each fully connected block may only be connected to an adjacent fully connected block by orthogonal connections (not diagonal connections).

When nodes included in the 3D mesh topology have a layout of P×Q×R, a block consisting of 4 nodes may have a layout of P-1×Q-1×R-1. A block that is located at an odd number position in the x-axis direction, the y-axis direction, and the z-axis direction may be a fully connected block, and a block positioned at an even number position in at least one of the x-axis direction, the y-axis direction and the z-axis direction may be a sparsely connected block. For example, since the block 410 is located first in the x-axis direction, the y-axis direction and the z-axis direction, the block 410 may be a fully connected block. Since another block including at least one of the nodes included in the block 410 is located at an even number position in at least one of the x-axis direction, the y-axis direction and the z-axis direction, the other block may be a sparse matrix block.

In an example embodiment, when fully connected blocks and sparsely connected blocks of the 3D mesh topology are placed in a set pattern as described above (e.g., interleaved and non-intersecting), among nodes, a single node may be connected to all its orthogonally adjacent nodes, and may be connected to four diagonally adjacent nodes among one or more diagonally adjacent nodes that are diagonally adjacent to the single node. Orthogonally adjacent nodes among the nodes adjacent to the single node may be nodes that are included in the same block as the single node and are adjacent in one of the x-axis direction, the y-axis direction, and the z-axis direction. Among the nodes adjacent to the single node, diagonally adjacent nodes may be nodes that are included in the same block, excluding orthogonally adjacent nodes. Since fully connected blocks in the 3D mesh topology are placed/defined so as not to share the same nodes (not intersect), an arbitrary node in the 3D mesh topology may only be contained in one fully connected block. However, depending on whether the arbitrary node included in the 3D mesh topology is a corner node, an edge node, a face node, or an interior node, the arbitrary node may be included in different numbers of sparsely connected blocks, as may be seen in the example of FIG. 4.

According to an example embodiment, among the nodes included in the 3D mesh topology 400, 8 nodes located at the corners of the 3D mesh topology 400 may be referred to as corner nodes. A corner node may be included in only one fully connected block and may not be included in a sparsely connected block. In the example shown in FIG. 4, the first node 411 may be a corner node. The first node 411 may be connected to all three of its orthogonally adjacent nodes that are orthogonally adjacent to the first node 411, and be connected to its four diagonally adjacent nodes that are diagonally adjacent to the first node 411. Referring to FIG. 4, three orthogonally adjacent nodes may include the second node 412, and the four diagonally adjacent nodes may include the third node 413 and the fourth node 414.

In the example of FIG. 4, among the nodes included in the 3D mesh topology 400, the 48 nodes located on the edges of the 3D mesh topology 400 that are not corner nodes may be referred to as edge nodes. An edge node may be included in one fully connected block and one sparsely connected block. The second node 412 may be an edge node. The second node 412 may be connected to all four of its orthogonally adjacent nodes that are orthogonally adjacent to the second node 412, and be connected to four of its seven diagonally adjacent nodes that are diagonally adjacent to the second node 412. Referring to FIG. 4, the four orthogonally adjacent nodes may include the first node 411 and the third node 413, and the four diagonally adjacent nodes may contain the fourth node 414.

Among the nodes included in the 3D mesh topology 400, 88 nodes that are located on the surfaces of the 3D mesh topology 400 but are not edge nodes may be referred to as face nodes. A face node may be contained in one fully connected block and three sparsely connected blocks. The third node may be a face node. The third node 413 may be connected to all five of its orthogonally adjacent nodes that are orthogonally adjacent to the third node 413, and be connected to four out of its 12 diagonally adjacent nodes that are diagonally adjacent to the third node 413. Referring to FIG. 4, the five orthogonally adjacent nodes may include the second node 412 and the fourth node 414, and the four diagonally adjacent nodes contain the first node 411.

According to an example embodiment, among the nodes included in the 3D mesh topology 400, the 48 nodes located inside the 6 faces of the 3D mesh topology 400 may be interior nodes. The interior nodes may be contained in one fully connected block and seven sparsely connected blocks. The fourth node 414 may be an interior node. The fourth node 414 may be connected to all six of its orthogonally adjacent nodes that are orthogonally adjacent to the fourth node 414, and be connected to four of its 20 diagonally adjacent nodes that are diagonally adjacent to the fourth node 414. Referring to FIG. 4, six orthogonally adjacent nodes may include the third node 413, and four diagonally adjacent nodes may include the first node 411 and the second node 412.

For convenience of explanation, features a 2D mesh topology are described, and such explanation is readily extended to a 3D mesh topology.

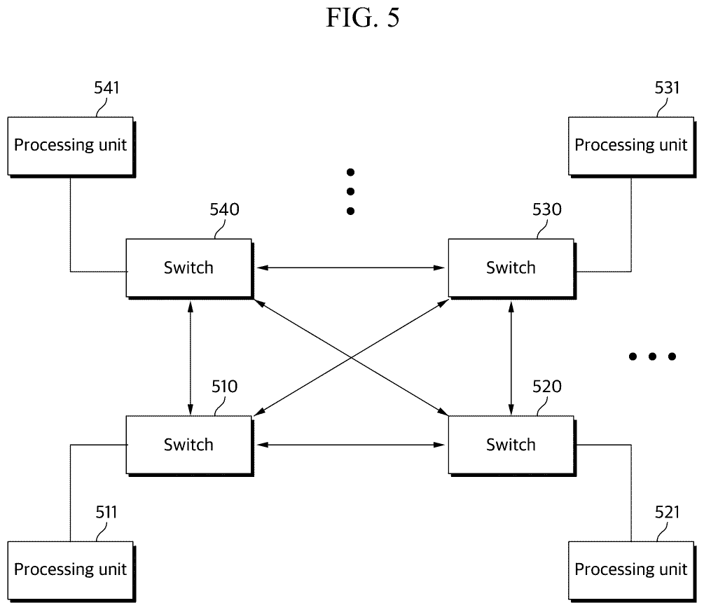

FIG. 5 illustrates an example of connection relationships between switches and processing units according to one or more embodiments.

In some implementations, one switch (a representative among the switches 101) may be connected to one processing unit among the processing units 102, and one processing unit (representative among the processing units 102) may be connected to the one switch. In other words, in an example implementation, the processing units 541 and the switches 540 may be respectively connected on a one-to-one basis; the processing units 541 and switches 540 may be arranged in pairs.

According to an example embodiment, switches 510, 520, 530 and 540 may correspond to nodes included in the block 310 of the 2D mesh topology 300. The switch 510 may correspond to the first node 311, the switch 520 may correspond to the second node 312, the switch 530 may correspond to the third node 313, and the switch 540 may correspond to the second node 314. The switch 510 may be connected to a processing unit 511, the switch 520 may be connected to a processing unit 521, the switch 530 may be connected to a processing unit 531 and the switch 540 may be connected to the processing unit 541. FIG. 5 illustrates only the connection relationship between the switches and the processing units in the 2D mesh topology, but switches and processing units having the 3D mesh topology may also be connected similarly.

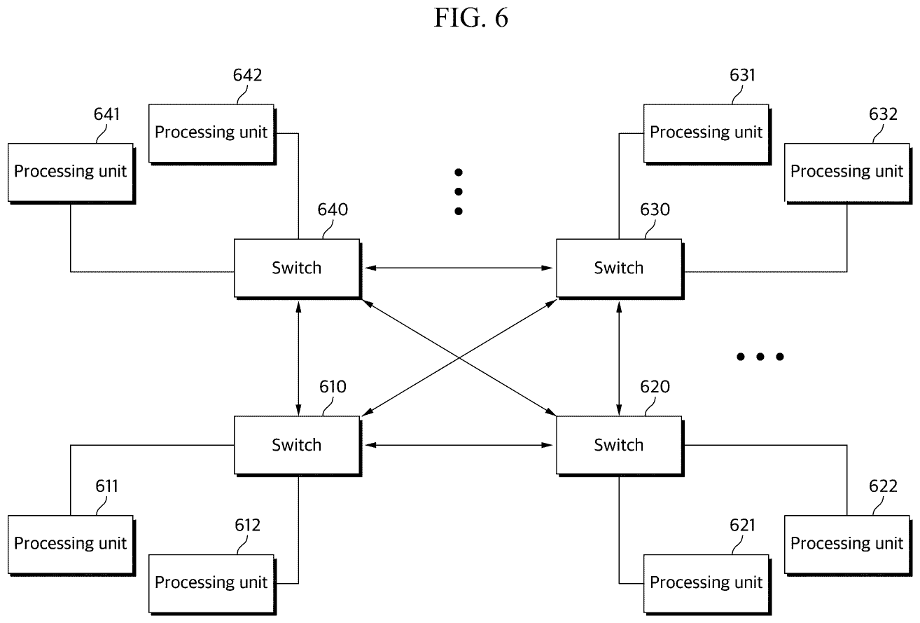

FIG. 6 illustrates another example of connection relationships between switches and processing units according to one or more embodiments.

One switch among the switches 101 may be connected to more than one processing unit among the processing units 102. For example, one switch among the switches 101 may be connected to two or more processing units among the processing units 102, and one processing unit among the processing units 102 may be connected to only one switch among the switches 101. In other words, the connection relationship between the switches and the processing units of FIG. 6 may be one-to-many. In this case, the nodes included in the mesh topology may be called concentrated nodes. Moreover, the number of processing units connected to a switch may vary from switch to switch.

According to an example embodiment, switches 610, 620, 630 and 640 may correspond to nodes included in the block 310 of the 2D mesh topology 300. The switch 610 may correspond to the first node 311, the switch 620 may correspond to the second node 312, the switch 630 may correspond to the third node 313, and the switch 640 may correspond to the second node 314. The switch 610 may be connected to a processing unit 611 and a processing unit 612, the switch 520 may be connected to a processing unit 621 and a processing unit 622, the switch 630 may be connected to a processing unit 631 and a processing unit 632, and the switch 640 may be connected to a processing unit 641 and a processing unit 642. FIG. 6 only illustrates the connection relationship between the switches and the processing units in the 2D mesh topology, but switches and processing units having the 3D mesh topology may also be connected similarly.

For convenience of explanation, examples are described where the connection between switches and processing units is in 1:1 manner.

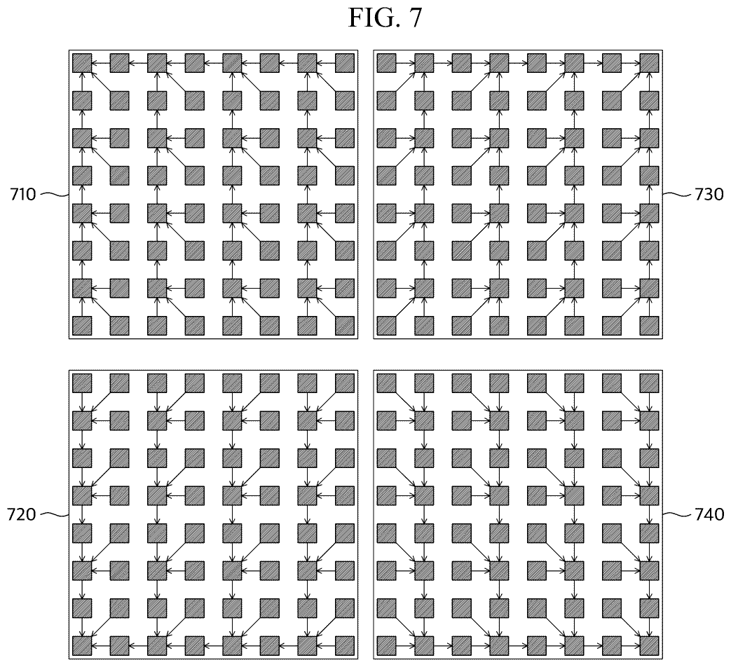

FIG. 7 illustrates disjoint spanning trees identified based on a mesh topology, according to one or more embodiments.

According to an example, the accelerator 100 may perform operations on multiple variables simultaneously by using spanning trees identified based on the mesh topology. The spanning trees may define routes for routing data through the mesh topology.

In an example, a spanning tree identified based on a mesh topology may be a tree that includes all the nodes included in the mesh topology, and connects the nodes to a minimum extent so that no cycle occurs. Depending on the connection relationship (e.g., diagonal or orthogonal) between two connected nodes included in the spanning tree, the node located at the upper end of the two nodes functions as the parent node of the spanning tree, and the other node located at the lower end functions as a child node. A node that has no child node functions as a leaf node. A node at the top of a tree that has no parent node functions as a root node. Nodes included in the spanning tree that are not leaf nodes or root nodes function as internal nodes.

According to an example, spanning trees identified based on a mesh topology may be disjoint spanning trees that do not share edges in the mesh topology. Referring to FIG. 7, each of the disjoint spanning trees 710, 720, 730 and 740 do not share edges in the 2D mesh topology 300. In other words, when simultaneously performing operations on variables using disjoint spanning trees, there is no simultaneous transmission of data through the same edge at the same time across different disjoint spanning trees, and thus operations on the variables may be performed more efficiently. In this regard, since it may be appropriate to perform operations on one variable using one spanning tree, the greater the number of spanning trees, the more operations on a large number of variables can be performed in parallel.

However, not all edges included in the 2D mesh topology 300 are necessarily included in one of the disjoint spanning trees 710, 720, 730 and 740. In other words, an edge included in the 2D mesh topology 300 may be included in at most one disjoint spanning tree among the four disjoint spanning trees. With regard thereto, the number of edges included in the example 2D mesh topology 300 is 288, and the number of edges included in the four disjoint spanning trees is 252, and thus the utilization rate of edges included in the 2D mesh topology 300 is 87.5%.

According to an example, each of the disjoint spanning trees 710, 720, 730 and 740 may use one corner node (among the corner nodes in the 2D mesh topology 300) as a root node. For example, the disjoint spanning tree 720 may use the first node 311, which is a corner node, as a root node. With regard thereto, since there are four corner nodes included in the 2D mesh topology 300, up to four disjoint spanning trees based on the 2D mesh topology may be identified/defined. Further, the number of variables may also be up to 4.

In contrast, among the nodes included in the 2D mesh topology, a single node may be connected to all of its orthogonally adjacent nodes, and may be not-connected to all of its one or more diagonally adjacent. When the connectivity between nodes is determined in the manner described above, the mesh topology may be referred to as the first mesh topology. When a 2D first mesh topology with an 8×8 layout is constructed based on the connection relationship, up to three disjoint spanning trees based on the 2D first mesh topology may be identified/defined. Furthermore, the number of edges included in the example 2D first mesh topology with an 8×8 layout is 224 and the number of edges included in the three disjoint spanning trees is 188, and thus the utilization rate of edges included in a 2D first mesh topology with an 8×8 layout is 83.9%. In other words, the case of determining the connection relationship between nodes, such as the 2D mesh topology 300 according to an example has higher usage rate of edges than the case of determining the connection between nodes, such as the first mesh topology. Therefore, the cost may be reduced. Furthermore, in the case of determining the connection relationship between nodes, such as the example 2D mesh topology 300, operations may be performed on more variables simultaneously than in the case of determining the connection between nodes, such as the first mesh topology. Thus, the operating speed may be relative faster.

The above described method for identifying/defining disjoint spanning trees based on the 2D mesh topology described with reference to FIG. 7 may similarly be applied to identify/define disjoint spanning trees based on the 3D mesh topology.

In some implementations, disjoint spanning trees may not share edges included in the 3D mesh topology. Further, each of the disjoint spanning trees may use one corner node (among the corner nodes in the 3D mesh topology) as a root node. With regard thereto, since there are 8 corner nodes included in the 3D mesh topology 400, up to eight disjoint spanning trees based on the 3D mesh topology may be identified. Further, the number of variables may also be up to 8 (each spanning tree processing one of the variables).

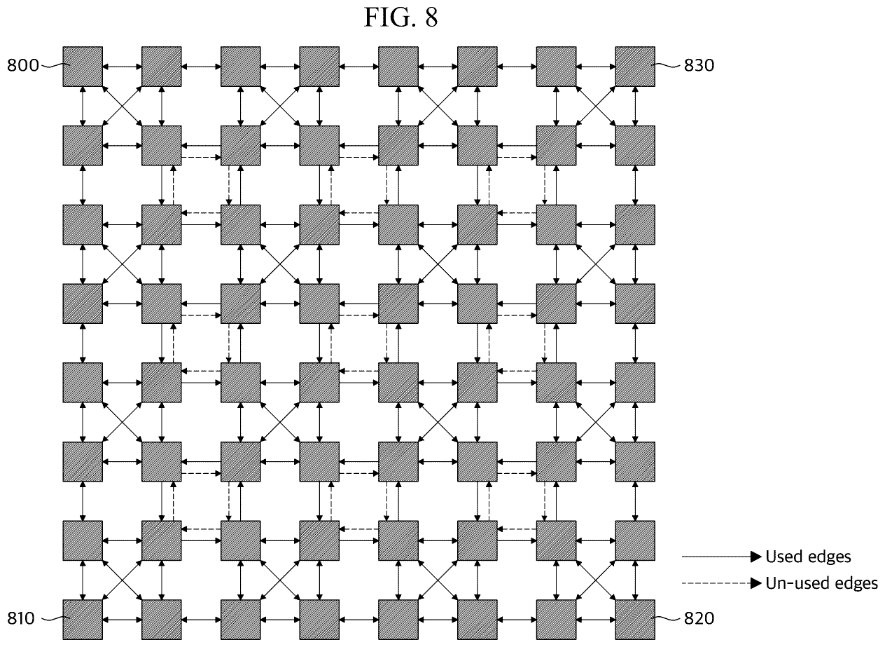

FIG. 8 illustrates edges included in disjoint spanning trees among the edges included in the mesh topology, according to one or more embodiments.

As described above, the number of edges included in the example 2D mesh topology may be 288, and the number of edges included in four disjoint spanning trees may be 252. More specifically, the edges indicated by solid lines in FIG. 8 represent edges included in a disjoint spanning tree. The edges indicated by dashed lines in FIG. 8 represent edges that are not included in four disjoint spanning trees. With regard thereto, the utilization rate of edges included in the 2D mesh topology 300 is 87.5%.

The processing units respectively connected to the switches corresponding to nodes 800, 810, 820 and 830, which are corner nodes included in the mesh topology, may further include (in addition to interfaces corresponding switch connections) an interface for connection to an external device. With regard thereto, the processing units connected to the switches corresponding to the nodes 800, 810, 820 and 830 may communicate with external devices via at least one of various interface protocols, such as USB, MMC (multimedia card), PCI-E, advanced technology attachment (ATA), Serial-ATA, Parallel-ATA, SCSI, ESDI, UFS, non-volatile memory express (NVMe) and integrated drive electronics (IDE), as non-limiting examples.

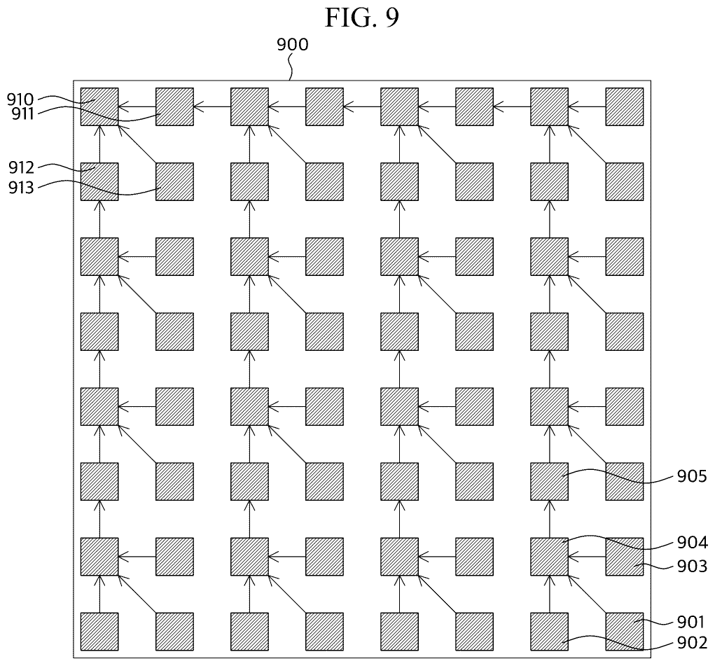

FIG. 9 illustrates a method of performing operations using a disjoint spanning tree, according to one or more embodiments.

According to an example implementation, the operation on the variables using the disjoint spanning trees may be an all-reduce operation on the variables. With regard thereto, the all-reduce operation for a first variable among the variables may be performed through a first disjoint spanning tree 900. The first disjoint spanning tree 900 may correspond to the disjoint spanning tree 710. The all-reduce operation may be performed for the purpose of maintaining data consistency in data parallel processing and ensuring that all nodes have the same latest result value.

The all-reduce operation may include a first operation in which a predetermined operation is performed based on data distributed across nodes, and a second operation in which a result value according to the all-reduce operation is broadcast to nodes. The predetermined operation may be any of a variety of operations such as addition, multiplication, and obtaining a maximum or minimum value, for example. However, other operations may be performed. With reference to FIG. 9, implementations where the predetermined operation is addition are described. The first operation may be called an all-reduce operation, and the second operation may be referred to as a broadcast operation.

The accelerator 100 may perform the all-reduce operation using multiple values corresponding to the first variable assigned to processing units according to the structure of the first disjoint spanning tree. In other words, the first operation may be an operation that sequentially performs a predetermined operation from a leaf node, through an internal node, to a root node based on values corresponding to the first variable assigned to the corresponding processing units.

A processing unit connected to a switch corresponding to a particular node may compute a value by performing the predetermined operation based on the value corresponding to the first variable allocated to the memory and the value received from the processing unit connected to the switch corresponding to each of one or more child nodes of a specific node. The processing unit connected to a switch corresponding to a specific node may transmit a computed value to a processing unit connected to a switch corresponding to a parent node of the specific node. For example, nodes 901, 902 and 903 may be leaf nodes since they have no child nodes. The processing unit connected to a switch corresponding to the node 901 may transmit a value corresponding to a first variable allocated to the memory (for example, 1) to the processing unit connected to a switch corresponding to a node 904, which is the parent node. Similarly, the processing unit connected to the switch corresponding to the node 902 may transmit the value corresponding to the first variable allocated in the memory (for example, 2) to the processing unit connected to the switch corresponding to the node 904, which is the parent node, and the processing unit connected to the switch corresponding to the node 903 may transmit the value corresponding to the first variable allocated in the memory (for example, 3) to the processing unit connected to the switch corresponding to the node 904, which is the parent node. The processing unit connected to the switch corresponding to the node 904 may calculate a value (for example, 10) by performing the predetermined operation based on the value corresponding to the first variable allocated to the memory (for example, 4) and the values received from the processing units corresponding to the nodes 901, 902 and 903. The processing unit connected to the switch corresponding to the node 904 may transmit the calculated value to a node 905, the parent node of the node 904. Similar operations may be performed in sequence, and ultimately, the processing unit connected to the switch corresponding to a node 910, which is the root node, may receive values from the processing units connected to the switches corresponding to nodes 911, 912, and 913, respectively. The aforementioned transmissions by the processing units is performed via their respective switches. The processing unit connected to the switch corresponding to the node 910, which is the root node, may compute the result value for the all-reduce operation on a first variable by performing the predetermined operation based on the values received and the value of the first variable assigned to the processing unit.

The accelerator 100 may store the result value according to the all-reduce operation in the processing unit corresponding to the root node. More specifically, the result value of the all-reduce operation may be stored in the memory of the processing unit connected to the switch corresponding to the root node.

The accelerator 100 may transmit the result values according to the all-reduce operation to the processing units corresponding to the remaining nodes (except the root node) among the nodes according to the structure of the disjoint spanning tree. In other words, the second operation may be an operation in which the result values according to the all-reduce operation are transmitted to the processing units connected to the switches corresponding to the internal nodes and leaf nodes (excluding the root node) according to the structure of the disjoint spanning tree.

The processing unit connected to a switch corresponding to a specific node may store in the memory (also referred as an internal memory of the processing unit) the result value according to the all-reduce operation received from the processing unit connected to the switch corresponding to the parent node of the specific node, and transmit the result value according to the all-reduce operation to a processing unit connected to a switch corresponding to each of one or more child nodes of the specific node. For example, the processing unit connected to the switch corresponding to the node 910, which is the root node, may transmit the result value according to the all-reduce operation to the processing unit connected to the switch corresponding to each of nodes 911, 912 and 913, which are child nodes. The processing unit connected to the switch corresponding to each of the nodes 911, 912 and 913 may store the result value according to the received all-reduce operation in the memory, and transmit the result value according to the all-reduce operation to the processing unit connected to a switch corresponding to the child nodes of the nodes 911, 912 and 913. Similar operations may be performed in sequence, and the processing unit connected to the switch corresponding to the node 904 may transmit the result value according to the all-reduce operation to the processing unit connected to the switch corresponding to each of the nodes 901, 902 and 903, which are child nodes. Accordingly, the processing unit connected to the switch corresponding to each of the nodes 901, 902 and 903 may store the result value according to the received all-reduce operation in the memory.

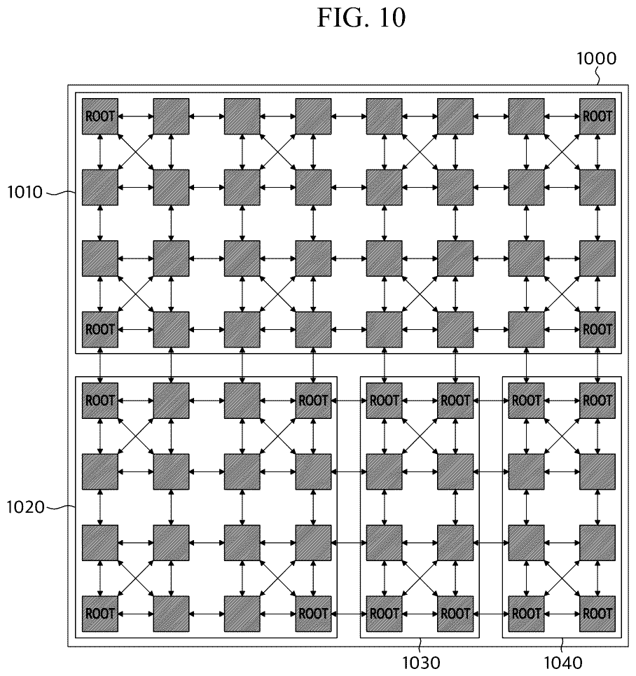

FIG. 10 illustrates a method of performing operations by dividing the mesh topology, according to one or more embodiments.

In some implementations, spanning trees may contain all the nodes included in the 2D mesh topology 300, but the present disclosure is not limited thereto. For example, when the 2D mesh topology may be divided into multiple subgroups, and spanning trees may only contain multiple first nodes belonging to a particular subgroup. Referring to the example of FIG. 10, a 2D mesh topology 1000 may include a first subgroup 1010, a second subgroup 1020, a third subgroup 1030 and a fourth subgroup 1040.

In some implementations, fully connected blocks and sparsely connected blocks included in a subgroup may also be arranged in a pattern set within the subgroup. In other words, the connection relationship between multiple first nodes included in a subgroup may correspond to the 2D mesh topologies described herein. For example, fully connected blocks included in the first subgroup 1010 are arranged so that they do not share the same nodes, and thus among first nodes, a given node is connected to all of its orthogonally adjacent nodes, and may be connected to a set number of diagonally adjacent nodes among its diagonally adjacent nodes. Similarly, multiple fully connected blocks included in each of the second subgroup 1020, the third subgroup 1030 and the fourth subgroup 1040 may also be arranged so as not to share the same nodes.

Among the nodes included in each of the first subgroup 1010, the second subgroup 1020, the third subgroup 1030 and the fourth subgroup 1040, four nodes located at the corners may be corner nodes, and may be used as root nodes when operations are performed. With regard thereto, referring to FIG. 10, in each of the first subgroup 1010, the second subgroup 1020, the third subgroup 1030 and the fourth subgroup 1040, the corner node available as a root node is marked as “ROOT.”

The accelerator 100 may perform operations on variables simultaneously using spanning trees identified based on each of multiple subgroups. For example, the accelerator 100 may perform operations on multiple first variables simultaneously using multiple first spanning trees identified/defined based on the first subgroup. Here, the number of multiple first variables may be up to four. When the 2D mesh topology is divided into multiple subgroups, the number of variables that may perform operations simultaneously may increase. More specifically, when the 2D mesh topology is divided into N subgroups, the number of variables that may perform operations simultaneously may be at most 4 N. For example, when the 2D mesh topology 1000 contains the first subgroup 1010, the second subgroup 1020, the third subgroup 1030 and the fourth subgroup 1040, the number of variables that may perform operations simultaneously based on the 2D mesh topology 1000 may be up to 16.

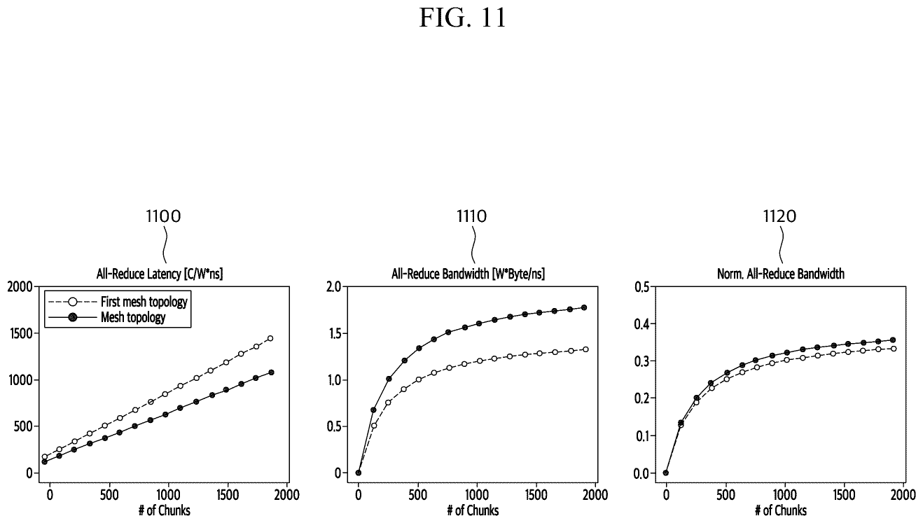

FIG. 11 illustrates a comparison between transmitting data based on a mesh topology according to one or more embodiments and a case of transmitting data based on a first mesh topology, in terms of latency and speed of data transmission, according to one or more embodiments.

Fully connected blocks and sparsely connected blocks included in the mesh topology may be arranged in a set pattern. Among the nodes included in the mesh topology, a given node may be connected to all of its orthogonally adjacent nodes, and may be connected to a set number of its diagonally adjacent nodes.

In contrast, among the nodes included in the first mesh topology, a given node may be connected to all of its orthogonally adjacent nodes, but may be not-connected to all of its one or more diagonally adjacent nodes. In other words, all blocks included in the first mesh topology may be sparsely connected blocks. Accordingly, when the nodes included in the mesh topology and the first mesh topology are placed identically, the mesh topology may contain more edges than the first mesh topology.

In an example embodiment, graphs 1100, 1110 and 1120 show performance results where nodes included in the mesh topology and the first mesh topology have a 128×128 arrangement. Graphs for cases where the nodes included in the mesh topology and the first mesh topology have different arrangements may also appear similarly to graphs 1100, 1110 and 1120.

Graph 1100 shows the latency of data transmission as a function of the amount of data being transmitted. Graph 1100 shows that as the amount of data being transmitted increases, the latency when transmitting data using the mesh topology and the first mesh topology also increases. Graph 1100 illustrates that when transmitting the same amount of data, the latency is shorter when using the mesh topology than when using the first mesh topology. In other words, using a mesh topology may be more efficient in terms of data transmission latency.

Graph 1100 shows transmission speed as a function of the amount of data being transmitted. Graph 1100 shows that as the amount of data being transmitted increases, the transmission speed when transmitting data using each of the mesh topology and first mesh topology increases rapidly and then becomes saturated. Further, graph 1100 shows that when the same amount of data is transmitted, when the mesh topology is used, the transmission speed is measured to be higher than when the first mesh topology is used. In other words, using a mesh topology may be more efficient in terms of data transmission speed.

When the nodes included in the mesh topology and the first mesh topology are placed identically, since the mesh topology contains more edges than the first mesh topology, it may be appropriate to compensate for the transmission speed based thereon. With regard thereto, each of the transmission speed when using a mesh topology and the transmission speed when using a first mesh topology may be compensated based on the number of edges included in the mesh topology and the number of edges included in the first mesh topology.

Graph 1120 shows the adjusted transmission speed as a function of the amount of data being transferred. Graph 1120 shows that when the same amount of data is transmitted, the case using the mesh topology has a higher measured corrected transmission speed than the case using the first mesh topology. In other words, even though the number of edges included in the mesh topology and the number of edges included in the first mesh topology are considered, the case where the mesh topology is used may be more efficient in terms of data transmission speed.

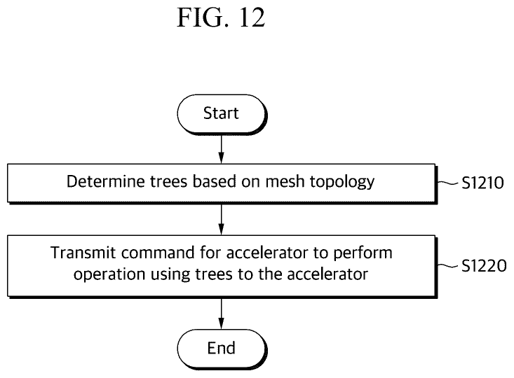

FIG. 12 illustrates an operation method of an electronic device according to one or more embodiments.

In an example embodiment, the electronic device 200 may include the memory 110, the one or more processors 120, and the accelerator 100 including the switches 101 having a mesh topology and the processing units 102 that are connected to the switches 101. Here, the mesh topology may include nodes corresponding to the switches 101 and edges connecting the nodes. Among the nodes, a given node may be connected to all of its orthogonally adjacent nodes, and may be connected to a set number of its diagonally adjacent nodes.

In operation S1210, the electronic device 200 may determine trees based on a mesh topology.

The electronic device 200 may identify/determine trees for performing operations on the accelerator 100. Each of the trees may be a tree for performing operations on respective different variables. Specifically, the trees may be disjoint spanning trees that do not share edges, and the operation may be an all-reduce operation. Further, each of the disjoint spanning trees may use one corner node (among corner nodes in the mesh topology) as a root node.

In some implementations, the electronic device 200 is configured to identify variables that are the target of an operation. The identified variables may respectively correspond to the trees. In other words, operations on the variables may be performed simultaneously via the trees.

In operation S1220, the electronic device 200 may transmit a command for the accelerator 100 to perform operation using the trees to the accelerator 100.

According to an example embodiment, to the accelerator 100, the electronic device 200 may transmit a command to control the accelerator 100 to perform operations on variables simultaneously using each of the trees. Specifically, trees may be a disjoint spanning trees that do not share edges, and when the operation is an all-reduce operation, the electronic device 200 may transmit to the accelerator 100 the command for the accelerator 100 to perform all-reduce operation for each plurality of variables using disjoint spanning trees.

According to an example embodiment, the command related to the all-reduce operation may include the first command for the accelerator 100 to perform an all-reduce operation on the first variable among variables. The all-reduce operation for the first variable may be performed based on the first disjoint spanning tree among the disjoint spanning trees.

The first command may include an operation command for the accelerator 100 to perform an all-reduce operation using multiple values corresponding to the first variable assigned to processing units according to the structure of the first disjoint spanning tree, and a broadcast command for the accelerator 100 to transmit the result value of all-reduce operation to processing units corresponding to the remaining nodes except the root node among nodes according to the structure of the first disjoint spanning tree. Based on the operation command, the accelerator 100 may first perform a first operation in which a predetermined operation based on the data distributed across the nodes is performed. Then, based on the broadcast command, the accelerator 100 may perform a second operation that broadcasts the result values of the all-reduce operation to the nodes.

The electronic device 200 according to the above-described examples and embodiments may include a processor, a memory for storing and executing program data, a permanent storage such as a disk drive, and/or a user interface device such as a communication port, a touch panel, a key and/or a button that communicates with an external device. Methods implemented as software modules or algorithms may be stored in a computer-readable recording medium as computer-readable codes or program instructions executable on the processor. Here, the computer-readable recording medium includes a magnetic storage medium (for example, ROMs, RAMs, floppy disks and hard disks) and an optically readable medium (for example, CD-ROMs and DVDs), but not a signal per se. The computer-readable recording medium may be distributed among network-connected computer systems, so that the computer-readable codes may be stored and executed in a distributed manner. The medium may be readable by a computer, stored in a memory, and executed on a processer.

The examples and embodiments may be represented by functional block elements and various processing steps. The functional blocks may be implemented in any number of hardware and/or software configurations (e.g., as code/instructions) that perform specific functions. For example, an example embodiment may adopt integrated circuit configurations, such as memory, processing, logic and/or look-up table, that may execute various functions by the control of one or more microprocessors or other control devices. Similar to that elements may be implemented as software programming or software elements, the example embodiments may be implemented in a programming or scripting language such as C, C++, Java, assembler, etc., including various algorithms implemented as a combination of data structures, processes, routines, or other programming constructs. Functional aspects may be implemented in an algorithm running on one or more processors. Further, the example embodiments may adopt the existing art for electronic environment setting, signal processing, and/or data processing. The computing apparatuses, the electronic devices, the processors, the memories, the information output system and hardware, the storage devices, and other apparatuses, devices, units, modules, and components described herein with respect to FIGS. 1-12 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-12 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An accelerator comprising:
switches having a mesh topology; and
processing units connected to the switches, respectively, wherein the mesh topology comprises nodes corresponding to the switches, and edges configured to connect the nodes, and
wherein the nodes comprise a given node that is connected to all of its orthogonally adjacent nodes in the mesh topology that are orthogonally adjacent to the given node, and connected to a set number of diagonally adjacent nodes among one or more of its diagonally adjacent nodes in the mesh topology that are diagonally adjacent to the given node.

2. The accelerator of claim 1, wherein the mesh topology is a 2D mesh topology and the set number is one.

3. The accelerator of claim 2, wherein the nodes comprise a first node that is a corner node, a second node that is an edge node, and a third node that is an interior node,
wherein the first node is connected to all of two orthogonally adjacent nodes that are orthogonally adjacent to the first node, and is connected to one diagonally adjacent node that is diagonally adjacent to the first node,
wherein the second node is connected to all of three orthogonally adjacent nodes that are orthogonally adjacent to the second node, and is connected to one diagonally adjacent node between two diagonally adjacent nodes that are diagonally adjacent to the second node, and
wherein the third node is connected to all of four orthogonally adjacent nodes that are orthogonally adjacent to the third node, and is connected to one diagonally adjacent node among four diagonally adjacent nodes that are diagonally adjacent to the third node.

4. The accelerator of claim 1, wherein the mesh topology is a 3D mesh topology and the set number is four.

5. The accelerator of claim 4, wherein the nodes comprise a first node that is a corner node, a second node that is an edge node, a third node that is a face node and a fourth node that is an interior node,
wherein the first node is connected to all of three orthogonally adjacent nodes that are orthogonally adjacent to the first node, and is connected to four diagonally adjacent nodes that are diagonally adjacent to the first node,
wherein the second node is connected to all of four orthogonally adjacent nodes that are orthogonally adjacent to the second node, and is connected to four diagonally adjacent nodes among seven diagonally adjacent nodes that are diagonally adjacent to the second node,
wherein the third node is connected to all of five orthogonally adjacent nodes that are orthogonally adjacent to the third node, and is connected to four diagonally adjacent nodes among 12 diagonally adjacent nodes that are diagonally adjacent to the third node, and
wherein the fourth node is connected to all of six orthogonally adjacent nodes that are orthogonally adjacent to the fourth node, and is connected to four diagonally adjacent nodes among 20 diagonally adjacent nodes that are diagonally adjacent to the fourth node.

6. The accelerator of claim 1, wherein a first switch among the switches is connected to one or more processing units among the processing units, and
wherein a first processing unit among the processing units is connected to one switch among the switches.

7. The accelerator of claim 1, configured to perform operations on variables simultaneously using a spanning trees of the nodes, which are determined based on the mesh topology.

8. The accelerator of claim 7, wherein the spanning trees are disjoint spanning trees that do not share edges.

9. The accelerator of claim 8, wherein the operations are all-reduce operations on the variables.

10. The accelerator of claim 8, wherein the mesh topology is a 2D mesh topology and a number of the variables is four or less, or
the mesh topology is a 3D mesh topology and a number of the variables is eight or less.

11. The accelerator of claim 9, wherein each of the disjoint spanning trees has a corresponding corner node in the mesh topology as a root node thereof.

12. The accelerator of claim 11, configured to:
perform an all-reduce operation using values corresponding to a first variable assigned to the processing units according to a structure of a first disjoint spanning tree among the disjoint spanning trees;
store a result value of the all-reduce operation in one or more processing units corresponding to the root node of the first disjoint spanning tree; and
transmit the result value to processing units corresponding to nodes except the root node of the first disjoint spanning tree among the nodes according to the structure of the first disjoint spanning tree.

13. The accelerator of claim 1, wherein each of the processing units comprises a memory and a graphics processing unit (GPU) or a neural processing unit (NPU).

14. The accelerator of claim 13, wherein the processing units respectively corresponding to corner nodes located at corners of the mesh topology comprise respective interfaces for connection to an external device.

15. The accelerator of claim 7, wherein the spanning trees are determined based on a subgroup comprising first nodes among the nodes included in the mesh topology.

16. An electronic device comprising:
one or more processors;
an accelerator comprising switches having a mesh topology, wherein the mesh topology comprises nodes corresponding to the switches and edges configured to connect the nodes, and processing units connected to the switches, respectively;
and a memory storing instructions configured to cause the one or more processors to:
determine trees based on the mesh topology; and
transmit, to the accelerator, a command for the accelerator to perform an operation using the trees,
wherein the mesh topology comprises fully connected blocks of first nodes and partially-connected blocks of second nodes that are distinct from the fully connected blocks, wherein the first nodes in each fully connected block are connected to each other, wherein diagonally adjacent second nodes in each partially-connected block are not connected to each other and the orthogonally adjacent second nodes in each partially-connected block are connected to each other, and wherein the fully connected blocks are separated from each other by the partially-connected blocks.

17. The electronic device of claim 16, wherein the trees are mutually disjoint spanning trees, wherein the operation is an all-reduce operation, and wherein the instructions are further configured to cause the one or more processors to:
identify variables that are targets of the all-reduce operation; and
transmit to the accelerator a command for the disjoint spanning trees to perform the all-reduce operation on the respective variables.

18. The electronic device of claim 17, wherein the disjoint spanning trees comprise respective corner nodes in the mesh topology as respective root nodes thereof,
wherein the command comprises a first command for the accelerator to perform an all-reduce operation on a first variable among the variables, and
wherein the first command comprises:
when the all-reduce operation on the first variable is performed based on a first disjoint spanning tree among the disjoint spanning trees,
an operation command for the accelerator to perform the all-reduce operation using values corresponding to the first variable assigned to the processing units according to a structure of the first disjoint spanning tree; and
a broadcast command for the accelerator to transmit a result value of the all-reduce operation to processing units corresponding to nodes except the root node among the nodes according to the structure of the first disjoint spanning tree.

19. An operation method of an electronic device comprising an accelerator comprising switches having a mesh topology and that are connected to respectively corresponding processing units, a memory, and a processor, the operation method comprising:
identifying trees based on the mesh topology; and
transmitting a command for the accelerator to perform an operation using the trees to the accelerator,
wherein the mesh topology comprises nodes corresponding to the switches, and edges configured to connect the nodes, and
wherein the nodes comprise a given node that is connected to all of its orthogonally adjacent nodes in the mesh topology that are orthogonally adjacent to the given node, and connected to a set number of diagonally adjacent nodes among one or more its diagonally adjacent nodes in the mesh topology that are diagonally adjacent to the given node.

20. A non-transitory computer-readable recording medium storing a program for executing the operation method of claim 19 on a computer.
